(19) United States
(12) Patent Application Publication
(10) Pub. No.: US 2008/0260352 A1
(43) Pub. Date: Oct. 23, 2008

(54) RECORDED ADVERTISEMENT ENHANCEMENT

(76) Inventor: Gary Turner, Parker, CO (US)

Correspondence Address: SHERIDAN ROSS PC, 1560 BROADWAY, SUITE 1200, DENVER, CO, 80202, US

(21) Appl. No.: 11/737,577

(22) Filed: Apr. 19, 2007

(51) Int. Cl. H04N 5/91

(52) U.S. Cl. 386/95; 386/E09.001

(57) ABSTRACT

Methods, and apparatuses for providing enhanced advertisements during playback of a recorded advertisement are provided. More specifically, when a recorded advertisement segment is being played and/or fast-forwarded an enhancement to the originally recorded advertisement is presented to the user thereby increasing user awareness of the product displayed during playback of the recorded advertisement.

### FIELD

The present invention is directed to interactive medias and more specifically methods, apparatuses, and systems for providing an enhanced advertisement during playback of a recorded program.

### BACKGROUND

Television (TV) has traditionally been used as a one-way communication medium in which the television network decides what programs will be shown at what times. Even with these restrictions TV has proven to be the worlds most popular media delivery device. However, due to certain limitations, TV technology has not been cultivated to the extent that Personal Computer (PC) technology has. More specifically, although TV advertising is a multi-billion dollar industry, many TV advertisements go unwatched or un-noticed. In fact, some companies will spend millions of dollars on a single ad campaign, but still cannot be sure how many people have watched their commercial. Further frustrating the issue is with the proliferation of Digital Video Recorders (DVRs), viewers are provided the ability to record a show and watch it at a later time. Many TV viewers when watching a recorded show will choose to fast-forward through all commercials. This action of fast-forwarding through advertisements results in lost advertising opportunities to the company who paid for an advertisement on the now recorded show. More specifically, many companies are paying for advertisement space that is never fully utilized because so many viewers have the capability of fast-forwarding through the commercial. This makes it increasingly difficult for companies to inform potential consumers of new products, improvements to old products, and the like.

An additional problem encountered by advertisers is that the very nature of TV makes it difficult, if not impossible, to determine exactly how many viewers have seen and paid attention to their commercial. As an illustration, a company may place an advertisement on a particular channel at a particular time. With various TV rating measurement methods, such as the Nielsen rating system, the advertiser can know how many TVs were “tuned in” to the channel containing their advertisement at the time when the advertisement was shown. However, current rating systems are unable to determine how many viewers were actually in front of their TV and paying attention to their TV when the commercial was presented. Additionally, with the use of DVRs, Nielsen ratings cannot currently factor in whether an advertisement has been viewed at normal speed or at a fast-forward speed. Rather, ratings are only able to track which shows have been recorded by a DVR or the like and when such recordings have been viewed. Since the price of TV advertisements is generally based on the ratings of a given show, many advertisers may be paying a premium for advertisements that go completely unwatched or are fast-forwarded through.

Conversely, some broadcast stations may choose to price advertisement space based only on “live viewership” since that method of pricing conforms more closely with historical practices. However, these broadcast stations are foregoing potential revenue for advertisements that may ultimately be viewed when a recording is watched.

There have been ideas presented to restrict fast-forwarding capabilities for a recorded TV program. However, these ideas have been met with fierce opposition from viewers that believe they have the right to use their DVR however they see fit, including fast-forwarding through commercials if they like. Users do not want to purchase a DVR system that restricts their choices while viewing recorded content. Unfortunately, the desires of users are in direct conflict with the desires of companies spending or receiving a substantial amount of money on TV advertisements.

Accordingly, what is desired is a way to ensure that advertisements placed in a given time-slot of a TV program are viewed or at least partially viewed while the corresponding time-slot of the TV program is being fast-forwarded.

### SUMMARY

The present invention is directed to solving these and other problems and disadvantages of the prior art. In accordance with certain embodiments of the present invention, a method for providing an enhanced TV viewing experience is provided. Specifically, one method of the present invention comprises:

recording a program broadcast as a Television (TV) signal;

identifying a first segment of interest in the recorded program, wherein a first content is displayed during a real-time presentation of the first segment;

displaying an enhanced content during a non-real-time presentation of the first segment of interest, wherein the enhanced content differs from the first content.

In another embodiment of the present invention, an enhanced television apparatus is provided comprising:

a receiver adapted to receive multi-media signals;

memory comprising a data storage area, wherein a program received at the receiver can be stored in the data storage area; and

a processor operable to identify a first segment of interest corresponding to a first content in the recorded program, determine that the first segment of interest is being presented after the first segment of interest was recorded, and in response thereto present an enhanced content during the first segment of interest.

The broadcast of a TV signal generally corresponds to the point in time when the program is broadcast across a transmission network and received at the STB. In one embodiment, the broadcast time corresponds to the time when a program may be viewed live or when the program is first aired for public viewing. In an alternative embodiment, the broadcast time may correspond to a point in time when a program is recorded.

A non-real-time presentation or time-shifted presentation of a program corresponds to a presentation of the program at a point in time not equal to the broadcast time or recording time of the program. Examples of a non-real-time presentation or time-shifted presentation may include, but are not limited to, viewing the recorded program at a time after broadcast or recording, pausing a live program or recorded program, fast-forwarding a recorded program, skipping a recorded program, rewinding a recorded program, and playing a recorded program in slow-motion.

One inventive aspect of the present invention is that the ability to present the enhanced content during a time slot originally allocated to the first content (e.g. an originally aired advertisement) is provided. This means that an enhanced content can be updated while the recorded program remains in memory. When the user finally views the recorded program, the most recent enhanced content is provided to the user. This means that a single user may view the same recorded program a plurality of times and each time a different enhanced content may be presented to the user during the same segment of interest within the recorded program. This affords advertisers the ability to customize recorded programs well after the programs have been broadcast and recorded.

The enhanced contents may be presented to users who are attempting to fast-forward or skip though commercial segments that have been paid for by companies wishing to advertise a new product and/or service. Embodiments of the present invention allow the user to view the recorded program as they desire but also provide the enhanced content to the user such that the advertising space that was paid for is put to some amount of use.

In accordance with one embodiment of the present invention, the enhanced content presented while a segment of interest is being fast-forwarded may correspond to interactive content, such as an interactive advertisement. Examples of both long and short-form interactive advertisements and other interactive TV media are described in U.S. patent application Ser. Nos. 11/425,652 filed Jun. 21, 2006, U.S. patent application Ser. No. 11/552,047 filed Oct. 23, 2006, and U.S. patent application Ser. No. 11/622,426 filed Jan. 11, 2007, all of which are hereby incorporated by reference in their entirety. In one embodiment, a user engages the interactive advertisements through the use of “triggers” transmitted along with broadcast data. The insertion of triggers into a broadcast stream is known in the art. Program content in which such triggers have been inserted is sometimes referred to as enhanced program content or as an enhanced TV program or video signal. However, “enhanced content” as used herein is not limited to interactive TV media, but may incorporate any other type of user-perceivable media including, without limitation, audio, video, and still images.

Triggers may be used to alert a STB that interactive content is available. The trigger may contain information about available enhanced content as well as the memory location of the enhanced content. A trigger may also contain user-perceptible text that is displayed on the screen, for example, at the bottom of the screen, which may prompt the user to perform some action or choose amongst a plurality of options. Thus, a user with a TV that has interactive functionality may be prompted at the beginning of an enhanced TV program to choose between interactive and passive (non-interactive) viewing of the enhanced TV program. If the user chooses passive viewing, any further triggers contained in the enhanced TV program may be ignored by the STB and the user will view the program in a conventional way. However, if the user chooses the interactive option, then further triggers may be embedded in the enhanced TV program.

Triggers may be inserted into the broadcast stream at various points along the broadcast path. Triggers may be inserted into the broadcast stream before broadcast of the content by a broadcast station or any other media provider. Thus, these triggers would be part of the broadcast stream received by cable head ends and further distributed to TVs within homes. TVs are provided with interactive functionality by their associated STBs.

One common method for inserting data such as triggers into an analog video signal is the placement of that data into the unused lines of the video signal that make up the vertical blanking interval (VBI). Closed caption text data is a well known example of the placement of data in the VBI of the video signal. The closed caption text data is typically transmitted during line 21 of either the odd or even field of the video frame in a National Television Standards Committee (NTSC) format. Closed caption decoders strip the encoded text data from the video signal, decode the text data, and reformat the data for display, concurrent with the video data, on a TV screen. Such closed caption decoders process the text data separately from the video signal.

The Advanced Television Enhancement Foruin (ATVEF) has defined protocols for Hypertext Markup Language (HTML)-based enhanced TV. These protocols allow the delivery of enhanced TV programs to STBs and other devices providing interactive functionality by various transmission means, including, but not limited to, analog, digital, cable, and satellite. For the NTSC format, ATVEF specifies the type of information that may be inserted into the VBI of the video signal and on which lines of the VBI that information may be inserted. ATVEF specifies line 21 of the VBI as the line for insertion of an “ATVEF trigger,” i.e. the information that the STB or other device with interactive functionality interprets to provide interactive features to the enhanced TV program. ATVEF-A triggers comprise a Universal Resource Locator (URL), which provides an Internet address from which interactive content may be downloaded, whereas ATVEF-B triggers themselves can contain interactive content.

As used herein “content” or “multi-media” programs include any type of user-perceptible substance that can incorporate visual and/or audio media. Content is typically in the form of video media or static pages that can be viewed on a TV or the like by a user. Examples of content and multi-media programs include, but are not limited to, a live broadcast that may be received from a satellite provider, a cable provider, or over free air, advertisements or information for certain products and/or services, recorded images, computer rendered images or other graphics, audio content, and so on.

The summary is not intended to provide an exhaustive description of all embodiments of the present invention. Namely, additional features and advantages of embodiments of the present invention will become more readily apparent from the following description, particularly when taken together with the accompanying drawings.

### BRIEF DESCRIPTION OF THE DRAWINGS

FIG. 1 is a block diagram depicting a broadcast and display system in accordance with embodiments of the present invention;

FIG. 2 is a block diagram depicting a STB and viewer control interface in accordance with embodiments of the present invention;

FIG. 3 is a block diagram depicting segments of a recorded program in accordance with embodiments of the present invention;

FIG. 4 is a screen shot depicting a segment of a recorded program being played back along with enhanced content in accordance with embodiments of the present invention;

FIG. 5 is a flow chart depicting a method of recording a broadcast program in accordance with embodiments of the present invention;

FIG. 6 is a flow chart depicting a method of viewing a recorded program in accordance with embodiments of the present invention;

FIG. 7 is a flow chart depicting a method of selecting an enhanced content for display with a recorded program in accordance with embodiments of the present invention;

FIG. 8 is a flow chart depicting a method of engaging an interactive type of enhanced content in accordance with embodiments of the present invention; and

FIG. 9 is a flow chart depicting a method of calculating viewer ratings based on activity associated with a particular segment of interest in accordance with embodiments of the present invention.

### DETAILED DESCRIPTION

The exemplary embodiments of this invention will be described in relation to enhancement of advertisement segments stored on a Digital Video Recorder (DVR) or other type of Set Top Box (STB), such as those designed and distributed by TiVo®. However, it should be appreciated, that in general, the systems and methods of this invention will work equally well for any type of communication system and data storage system in any environment.

The exemplary systems and methods of this invention will also be described in relation to television broadcast systems and associated communication hardware, software and broadcast channels. However, to avoid unnecessarily obscuring the present invention, the following description omits well-known structures, network components and devices that may be shown in block diagram form, are well known or are otherwise summarized.

For purposes of explanation, numerous details are set forth in order to provide a thorough understanding of the present invention. It should be appreciated, however, that the present invention may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a television broadcast network and/or the Internet, or within a dedicated secure, unsecured and/or encrypted system. Thus, it should be appreciated that the components of the system can be combined into one or more devices, such as a broadcast head end, or collocated on a particular node of a distributed network, such as an analog and/or digital broadcast network. As will be appreciated from the following description, and for reasons of computational efficiency, the components of the system can be arranged at any location within a distributed network without affecting the operation of the system. For example, the various components can be located in a broadcast head end server, at one or more users' premises, or some combination thereof. Similarly, one or more functional portions of the system could be distributed between a Set Top Box (STB), a display apparatus, and/or an associated computing device.

Embodiments of the present invention are generally directed toward methods and systems for administering ITV and creating an enhanced TV viewing experience. Although well suited for use with a television or similar type of display apparatus in conjunction with a STB, those skilled in the art can appreciated that embodiments of the present invention may also be implemented in conjunction with a simple television set not including a STB. Moreover, the systems and methods described in the present disclosure may be implemented in any media that may be enhanced through the use of events including, but not limited to, triggers that are synchronized to user-perceptible segments in a broadcast or other type of content.

As used herein “viewer” and “user” are used synonymously to refer to any person or thing that is currently making use of and/or interacting with the enhanced television system.

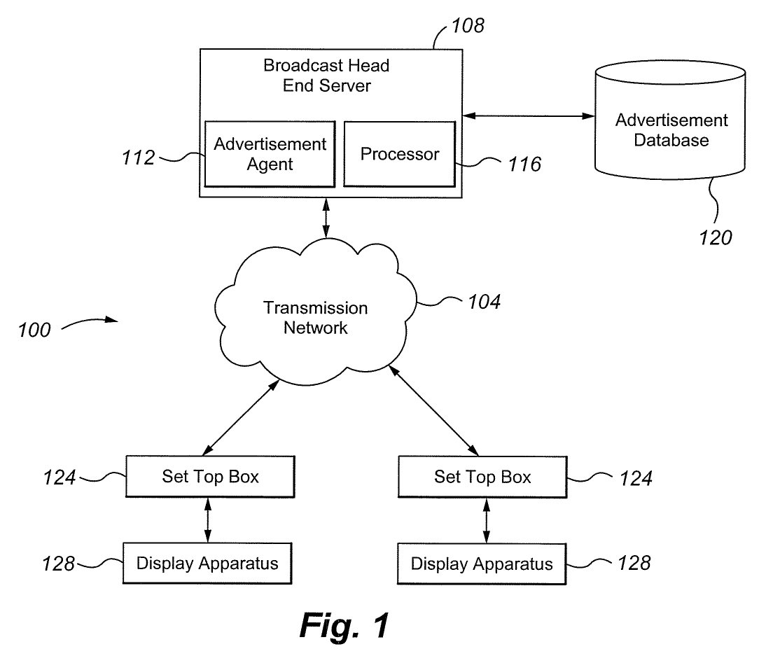

Referring now to FIG. 1, one embodiment of a broadcast system 100 will be described in accordance with embodiments of the present invention. The broadcast system 100 may comprise a transmission network 104, a broadcast head end server 108 including an advertisement agent 112 and a processor 116, an advertisement database 120, a plurality of set top boxes (STBs) 124, and a plurality of display apparatuses 128. Each STB 124 and display apparatus 128 may generally comprise a TV system and although each display apparatus 128 is depicted with a corresponding STB 124, the display apparatus 128 may be directly connected to the transmission network 104, thereby obviating the need for a STB 124.

In accordance with one embodiment of the present invention, the transmission network 104 is characterized by a number of signal carrying and relaying devices. The transmission network 104 may comprise an over-air transmission network where a terrestrial transmitter transmits TV signals. Alternatively, or in addition, the transmission network 104 may comprise a satellite transmission network employing terrestrial based and satellite based signal transmitters. In a satellite transmission network, signals may be initially transmitted by a base terrestrial transmitter and may be relayed by satellites orbiting in the Earth's atmosphere to satellite receivers associated with users of the network 104. In such an embodiment, the satellite receiver is connected to the STB 124, which decodes the signal received at the satellite receiver.

Another type of transmission network 104 that may be employed is a cable network. A cable network may comprise an extensive network of cables (e.g., coaxial, fiber optic, etc.) that are used to carry signals from the broadcast head end server 108 to each network user. Any other type of known transmission network 104 may be employed in accordance with embodiments of the present invention.

The broadcast head end server 108, in accordance with one embodiment of the present invention, is characterized by the ability to process a number of different broadcast programs associated with a number of different broadcast stations for transmission across the transmission network 104. The broadcast head end server 108 may comprise a single server or a number of servers (i.e., a server pool) each having capabilities of the broadcast head end server 108 described herein. The term “server” as used herein should be understood to any type of dedicated processing resource such as a media server, a broadcast server, computers, adjuncts, etc.

The broadcast head end server 108 may receive broadcast feeds from a number of different sources, such as different broadcast stations. Within such broadcasts, the broadcast stations may incorporate a number of different advertisements or advertisement segments. Generally, the advertisement segments may be filled with advertisements from the broadcast station. Alternatively, some broadcast segments may be dedicated for local advertisements. Such local advertisements may be inserted to the program at the broadcast head end server 108. Still further in the alternative, the broadcasts may be provided to a user by the broadcast head end server 108 in an on-demand fashion. When a user requests a particular program from a broadcast head end server 108, the server 108 may retrieve the program from an appropriate source and “broadcast” the program to the requesting user only through use of a buffer system between the broadcast head end server 108 and the appropriate STB 124.

The broadcast head end server 108 may be in communication with an advertisement database 120. The advertisement database 120 may be employed to store a number of different advertisements of various lengths from a number of different companies. Advertisements stored in the advertisement database 120 may be provided by the broadcast head end server 108 as enhanced content for presentation with a recorded program. The advertisement agent 112 may be employed by the processor 116 to insert such enhanced content into a broadcast signal for presentation during playback of a recorded program. The advertisement agent 112 may also contain instructions for monitoring the activity of display apparatuses 128 and/or STBs 124 to determine when a particular segment of interest in a recorded program is being played and more specifically when the segment of interest is being fast-forwarded or processed in a similar type of time-shifted fashion such as being played in slow-motion, being skipped, being reversed, being replayed at a time substantially after the program was recorded and so on.

The advertisements stored in the advertisement database 120 may include normal advertisements used to update older advertisements that have been recorded, short advertisements for presentation while a recorded advertisement is being fast-forwarded, reversed, skipped, and/or interactive advertisements comprising triggers for facilitating user interaction with the advertisement.

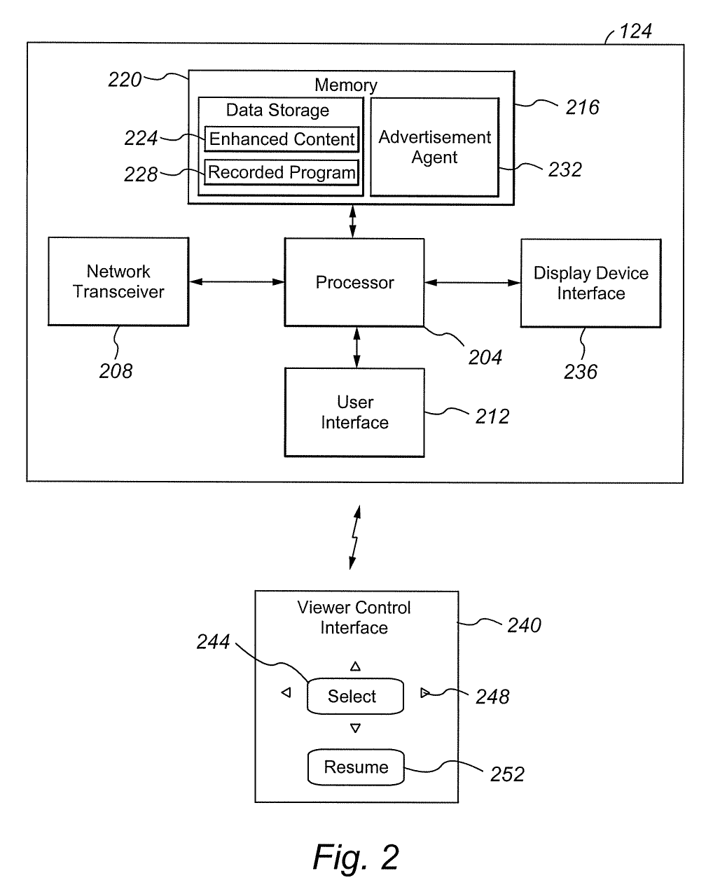

With reference now to FIG. 2, a STB 124 and viewer control interface 232 will be described in accordance with at least some embodiments of the present invention. The STB 124 may comprise a processor 204, a network transceiver 208, a user interface 212, memory 216 including data storage 220 and an advertisement agent 224, and a display apparatus interface 236.

The processor 204 may be implemented as a microprocessor or similar type of processing chip. The processor 204 may complete executable instructions or routines stored in a portion of memory 216. Alternatively, the processor 204 may be implemented in the form of an application specific integrated circuit (ASIC) that is operable to perform predefined functions based on predetermined inputs. The processor 204 generally functions to run programming code including operating system software, and one or more applications implementing various functions performed by the STB 124.

The memory 216 may be implemented as a volatile or non-volatile memory, or combinations thereof. For example, the memory 216 may comprise a temporary or long-term storage of data or processor instructions. Such data and processor instructions may be stored in the data storage 220. The memory 216 may be used in connection with implementing an interactive application for presentation on the display apparatus 128. The memory 216 may comprise solid-state memory resident, removable or remote in nature, such as DRAM, SDRAM, ROM, and EEPROM.

Enhanced content 224 such as, for example, interactive advertisements, updated advertisements, short advertisements, still images, and the like may be stored on the data storage 220 for quick access and presentation of such content while a segment of interest is being played in a time-shifted manner (e.g., in a non-real-time speed such as fast-forward, skipped, reverse, slow-motion, etc. or at normal speeds but at a time after recording the program). The data storage 220 may include content similar to the type of content stored in the advertisement database 120. A recorded program 228 may also be stored in the data storage 220. Upon recording a program, one or more enhanced contents 224 associated with the recorded program 228 may also be stored on the data storage 220 with a link between the enhanced content 224 and the recorded program 228. Therefore, when the recorded program 228 is being replayed and it is determined that the enhanced content 224 should be presented to a user, the enhanced content 224 may be retrieved from the local memory 216 rather than waiting for retrieval of the enhanced content from the broadcast head end server 108. Additionally, enhanced content 224 associated with a recorded program may be updated when the broadcast head end server 108 transmits new enhanced content 224 for display with the recorded program. In such an embodiment, the memory location of the enhanced content 224 is used to store the new enhanced content 224 and a link or pointer from the recorded program 228 may simply identify the memory location of the enhanced content 224 rather than the content itself. Accordingly, the enhanced content 224 may be updated a number of times while a recorded program 228 resides on the memory 216 and no changes to the recorded program 228 are required.

The memory 216 may also include an advertisement agent 232. The advertisement agent 232 may be used to locally monitor the presentation of recorded programs 228 and determine when a segment of interest is being displayed during such presentation of the recorded program 228. In accordance with embodiments of the present invention, the advertisement agent 232 may determine when a segment of interest is being played in a time-shifted manner. In one embodiment, the advertisement agent 232 identifies and retrieves enhanced content 224 for display with a recorded program. Alternatively, the advertisement agent 232 may report that a segment of interest is being played to the broadcast head end server 108, where the advertisement agent 112 at the broadcast head end server 108 is able to retrieve the proper enhanced content from the advertisement database 120 and transmit it as a part of the broadcast to the proper STB 124.

The STB 124 is operable to communicate with the broadcast head end server 108 via the network transceiver 208. The network transceiver 208 may comprise a coaxial cable connection, a USB port or other type of serial port, a modem, an Ethernet adapter, a satellite adapter, or the like. Content received at the network transceiver 208 is communicated to the processor 204 and/or the memory 216. Content that may be transmitted to the STB 124 includes, but is not limited to, live broadcasts from cable, satellite, or radio waves, songs, application data, application results, recorded video and static images, computer rendered images, specialized advertisements, triggers, and the like. The transceiver 208 may also be used to transmit data to the broadcast head end server 108.

The user interface 212 may comprise a receiver for communicating with a viewer/user control interface 240 such as a conventional wired or wireless TV remote control, a universal remote control, or the like. The user interface 212 may include an infrared (IR) receiver for receiving signals from an IR controller. The user interface 212 may also comprise a keyboard, mouse, or other type of direct user input. A user may employ the viewer control interface 240 to interact with interactive content and/or to navigate other types of content presented to the user. The viewer control interface 240 may include a select button 244 that can be used to select a trigger to engage in interactive content as well as arrow buttons 248 that can be utilized to navigate interactive content and chose between a number of presented triggers. The viewer control interface 240 may further include a resume button 252 that allows the user to navigate back to the previous screen without engaging a particular trigger.

The display device interface 236 provides the STB 124 the ability to communicate with the display apparatus 128. The display device interface 236 may include wired or wireless communication equipment. For example, the display device interface 236 may comprise a USB port or video jack. Alternatively, the display device interface 236 may comprise an RF transceiver for transmitting/receiving RF signals to/from the display apparatus 128.

Typically, enhanced content 224 and recorded programs 228 are stored in the memory 216 when they are received at the network transceiver 208. The content is typically stored in a particular address of the memory such that it can be easily retrieved at a later time. In normal operation, enhanced content 224 updates are sent to the STB 124 during idle periods (i.e., when the user is not viewing a live broadcast). However, content can also be sent to the STB 124 during a live broadcast through one or more VBIs as packets of information that can be stored in memory 216 while the live broadcast is being displayed. The packets of information can then be stored in memory 216 (e.g., a buffer memory) and reconstructed by the processor 204. Alternatively, enhanced content 224 is transmitted simultaneously with its associated program such that if the program is recorded, the enhanced content 224 is also recorded. The enhanced content 224 is typically not displayed along with the real-time presentation of the program but is instead reserved for use during a time-shifted presentation of the recorded program 228. However, in accordance with at least some embodiments of the present invention, enhanced content 224 may be displayed or at least accessed during the real-time presentation of the program. For example, if the enhanced content 224 comprises an interactive advertisement, the interactive advertisement may be accessed during the presentation of the real-time program but may also be accessed during the presentation of the recorded program 228.

As noted above, the enhanced content 224 may include interactive applications and/or interactive advertisements that are access by a trigger. A trigger usually contains an address, pointer, or some other sort of reference to the stored content or a live broadcast. When a user activates a trigger during a broadcast, the processor 204 uses the address of stored content associated with the trigger to retrieve the content from memory 216 or from the broadcast head end server 108. In the event that the content associated with the trigger is a live broadcast, then the trigger references the channel where the live broadcast can be found. Subsequently, the content can be displayed to a user via the display apparatus 128. Thus, multiple pre-stored contents can be maintained in the memory 216 for later display at the appropriate time or a user can navigate multiple live contents via triggers.

Generally, a trigger is transmitted along with a broadcast and both are displayed to a user via the display apparatus 128. A user is able to select the displayed trigger via the user interface 212. The processor 204 registers the request, determines the address of the stored content in memory 216, and retrieves the associated content from the memory 216. Alternatively, the processor 204 registers the request and determines the address of the live broadcast content on another channel. Thereafter, the requested content is transmitted to the display apparatus 128 for presentation to the user.

Selection of a trigger may also indicate that the content displayed on the display apparatus 128 is to be altered. In other words, engagement of a trigger may indicate that the display is to be altered to incorporate at least two different images, each associated with a different content. For instance, if a trigger is selected the presentation of the recorded program 228 may be supplemented with the presentation of the enhanced content 224.

A trigger can be transmitted with a broadcast, a live advertisement, and/or an interactive advertisement (e.g., a short form or long form advertisement). The trigger is used to begin interaction with the enhanced content 224 stored in memory 216 and/or on the broadcast head end server 108.

In accordance with at least some embodiments of the present invention, content associated with the trigger may be live content on a different channel. The trigger presented to the user may include a question asking the user if he/she would like to change channels. When the trigger is actuated, a portion of the display apparatus 128 is changed from the original channel to the new channel associated with the trigger.

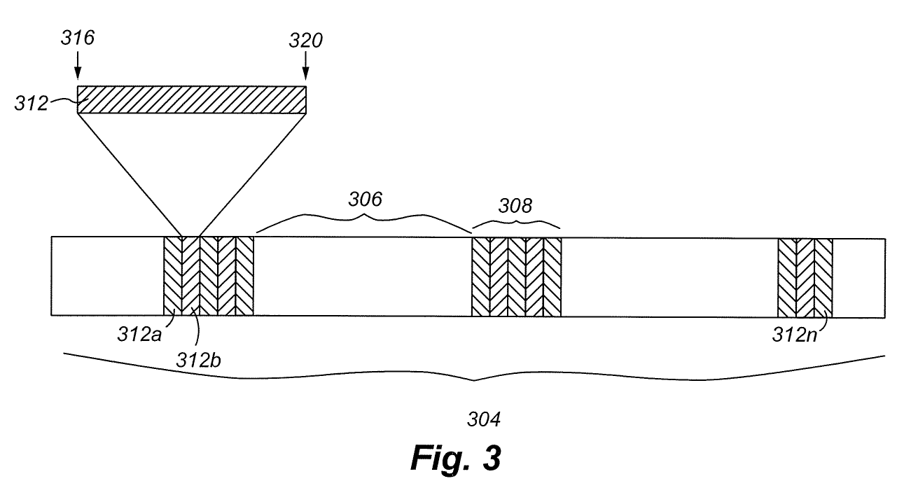

FIG. 3 depicts time-block view of a program, such as a recorded program 228, in accordance with at least some embodiments of the present invention. A program broadcast across the transmission network 104 may generally include program content as well as advertisement content. The duration of the program 304 may therefore be comprised of show segments 306 as well as advertisement segments 308. The show segments 306 may contain the content of the show currently being broadcast whereas the advertisement segments 308 may include a plurality of sub-segments 312a-N. Each advertisement sub-segment 312 may be filled with an advertisement or advertisement space for a different product/service or different advertisements for the same product/service. The total program 304 is generally configured to include advertisement segments 308 that separate the show segments 306.

The beginning 316 and end 320 of each sub-segment 312 may be defined by time markers or specific times measured relative to the beginning or ending of the program. The beginning 316 and end 320 may alternatively be identified based on when the program started recording. For example, the beginning 316 of an advertisement sub-segment 312 may be identified as 3 minutes and 12 seconds after the recording of the program began or as 5 minutes after the actual program began. Alternatively, the segments 308 and sub-segments 312 may be time stamped with the time that the given segment was broadcast in real-time. The beginning and ending points of advertisement segments 308 may be determined based on the beginning 316 and ending 320 points of sub-segments 312 within the segment 308.

The sub-segments 312 may be recorded with a first advertisement associated therewith. However, the sub-segment 312 may also be recorded with a pointer or link to enhanced content 224 that is to be presented in addition to or in substitution of the originally recorded advertisement when the sub-segment 312 is played back at a later time. Additionally, a sub-segment 312 and/or segment 308 may have a number of different pointers each associated with a different playback speed or operation. When a given segment 308 or sub-segment 312 is being skipped or fast-forwarded at a rapid rate, a first enhanced content 224 may be presented for the corresponding segment. Alternatively, if the segment 308 or sub-segment 312 is being played in reverse, a second different enhanced content 224 may be presented for the corresponding segment. Furthermore, if the segment 308 or sub-segment 312 is being replayed in normal speed, an updated enhanced content 224 may be presented for the corresponding segment. Each enhanced content 224 may be customized for the corresponding speed and mode of playback for the recorded program.

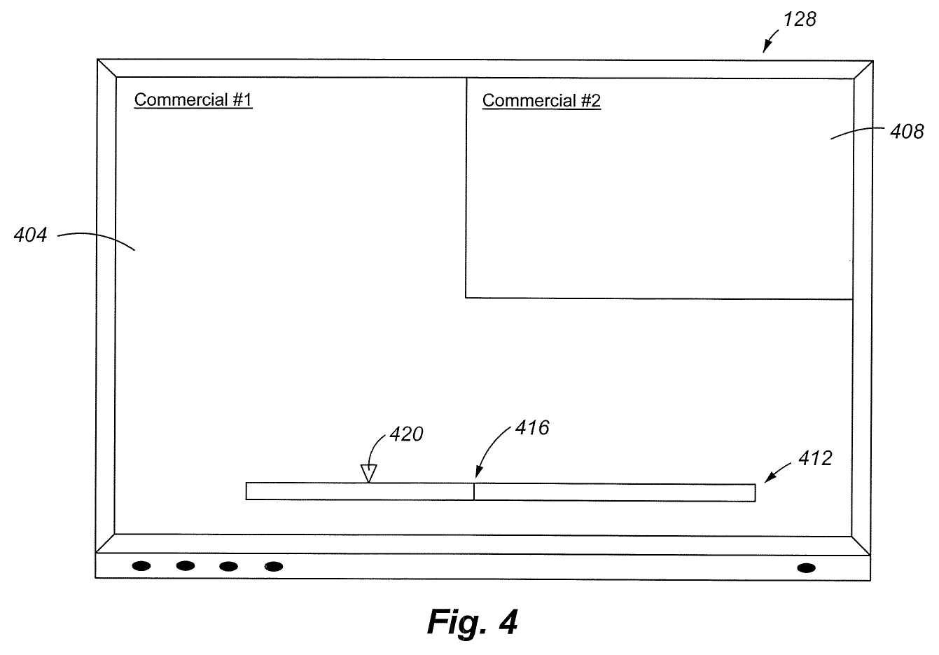

With reference now to FIG. 4, a screen shot of a recorded program 228 being played will be described in accordance with at least some embodiments of the present invention. A recorded program 228 may be retrieved from memory 216 and presented to a user via the display apparatus 128. As the user views the recorded program 228 at real-time speed, the entirety of the display apparatus 128 may be filled with the recorded program. However, if the user elects to alter the speed of playback of the recorded program 228, the display apparatus 128 may be divided into a first 404 and second portion 408. The first portion 404 may be used to continue presenting the recorded program 228, albeit at a non-real-time speed, whereas the second portion 408 may be used to present enhanced content 224.

In accordance with one embodiment, when a selected segment (e.g., an advertisement segment 308 or sub-segment 312) is being played at a faster than real-time speed a shorter enhanced content 224 is presented to the user in the second portion 408. This allows the user to continue viewing the progress of the recorded program 228 while allowing a company to present an advertisement to the user in the second portion 408. In accordance with at least one embodiment, the advertisement being displayed in the first portion 404 may be related to the enhanced content 224 being displayed in the second portion 408. For instance, an advertisement in the first portion 404 may correspond to a particular soft drink brand and a second advertisement for the same soft drink brand may be presented in the second portion 408. This allows a particular advertiser to ensure that a purchased advertisement space is utilized to present an advertisement to a viewer. Alternatively, the second portion 408 may be sold as a separate advertisement space than the first portion 404 and may therefore contain an advertisement for a completely unrelated product and/or service.

The embodiment depicted provides for the simultaneous display of more than one content, namely an enhanced content 224 and a recorded program 228. However, embodiments of the present invention allow for the presentation of an enhanced content 224 along with a live broadcast. The live broadcast may be transmitted with an indicator at the beginning of each segment of interest that triggers the display of the enhanced content 224. In such an embodiment, the live broadcast may be displayed in the first portion 404 while the enhanced content 224 is displayed in the second portion 408.

In an alternative embodiment, the display of the enhanced content 224 may preempt the display of the live broadcast (or the recorded program 228). Such a situation may occur when the enhanced content 224 comprises an interactive application such as an interactive short-form advertisement, an interactive long-form advertisement, interactive games, and the like. In this embodiment, the enhanced content 224 is displayed and the broadcast or recorded program 228 is paused at the point in time where the user began interacting with the application. The user is then allowed to interact with the enhanced content 224 on a full screen display. Once the user is done interacting with the application, the display is returned to the previous broadcast or recorded program 228 at the same point in time where the user began interacting with the application.

The display apparatus 128 may further include a progress indicator bar 412. The progress indicator bar 412 may include a program size indicator 416 and a display time indicator 420. The display time indicator 420 shows the point in time of the recorded program 228 that is currently being displayed to the user. The program size indicator 416 indicates the amount of time that is currently stored for the given program, whereas the total progress indicator bar 412 may be scaled for the anticipated recording time. For instance, if a user has requested to record a one hour program, then the relative length of time represented by the progress indicator bar 412 would be one hour, whereas the program size indicator 416 depicts the amount of the program that is currently recorded. The user may be allowed to view any portion of the program up to the end of the program size indicator 416. Of course, as the user continues to record a program, the program size indicator 416 may continue to grow.

A user may use the display time indicator 420 to determine what point of the program they are viewing relative to the entire program. Additionally, the advertisement agent 112, 232 may use the time indicator 420 to identify when a particular segment 308 or sub-segment 312 is being presented to a user. If the advertisement agent 112, 232 determines that a user is currently being presented with a segment of interest, then enhanced content 224 may be displayed to the user along with the recorded program 228 or instead of the recorded program 228.

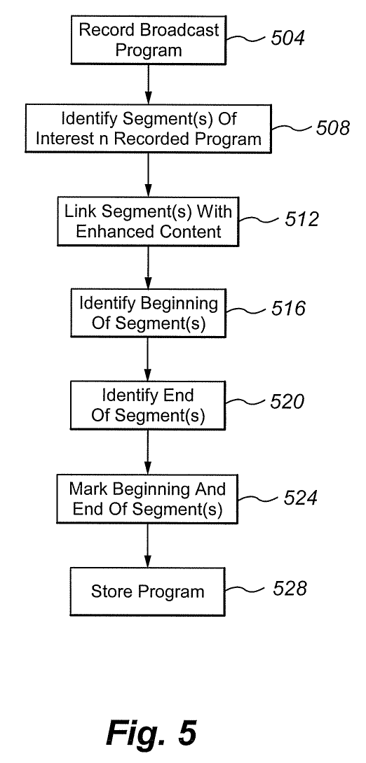

FIG. 5 is a flow chart depicting a method of recording a broadcast multi-media program in accordance with at least some embodiments of the present invention. The method begins when a program is recorded (step 504). The program that is recorded may have been transmitted in connection with a broadcast TV signal. In such an embodiment, the program may be recorded onto a hard disk drive type of memory on a STB 124. Alternatively, the program may be recorded onto a portable type of memory such as a CD, a DVD, Flash memory, or similar type of computer readable medium. The program may be recorded directly at the point of capture. For instance, a movie or TV program may be captured then recorded onto a portable type of memory device without actually being broadcast across the transmission network 100.

After the program has been recorded, one or more segments of interest in the recorded program are identified (step 508). Although a number of segments of interest may reside on a single program, sometimes in a back-to-back fashion, the rest of the method will be described with respect to a single segment of interest. The segment of interest may correspond to a segment 308, a sub-segment 312, or a show segment 306 of a broadcast program 304. The segment of interest may also correspond to a movie preview on a DVD or similar type of advertisement.

With the segment of interest identified, the segment is linked with an enhanced content 224 (step 512). In this step, the segment of interest may be stored with a pointer that can be used to dynamically locate and retrieve an enhanced content 224 from a particular memory address. Alternatively, linking a segment of interest with an enhanced content 224 may comprise storing the enhanced content 224 on a memory address logically adjacent to the memory address where the segment of interest is stored. Still further in the alternative, the linking of a segment of interest with an enhanced content 224 may comprise acknowledging that a segment of interest exists and the advertisement agent 112, 232 may maintain the identity of the segment of interest in a look up table that has a corresponding enhanced content 224 linked thereto.

Thereafter, the beginning and the end of the segment of interest are identified (steps 516 and 520 respectively). The beginning and end of the segment of interest is identified such that the real-time duration of the segment of interest can be calculated. Furthermore, it is advantageous to identify the boundaries of the segment of interest so that when the play indicator approaches the segment of interest the proper enhanced content 224 can be retrieved and presented during the segment of interest in a seamless fashion. In one embodiment, the boundaries of the segment of interest are identified based on their play time relative to when the recording began. In another embodiment, the boundaries of the segment of interest are identified based on their play time relative to when the program began. In still another embodiment, the boundaries of the segment of interest are identified based on the time that the live program was broadcast to the user. After the boundaries of the segment of interest have been identified, the boundaries are marked (step 524). The boundaries may be marked by storing a logical indicator along with the program or by storing the identified times when the boundaries occur within the recorded program.

After the boundaries of the segment of interest have been marked, the information related to the segment of interest along with the program itself is stored in memory (step 528). In accordance with some embodiments, the information related to the segment of interest and the program may be stored on a similar storage medium (e.g., on a common CD, DVD, hard disk drive, etc.). In other embodiments, the program may be stored on a first storage medium while the information related to the segment of interest may be stored on a second different storage medium. Additionally, copies of the information may be stored at the broadcast head end server 108 and/or the advertisement database 120 in addition to being stored at the STB 124.

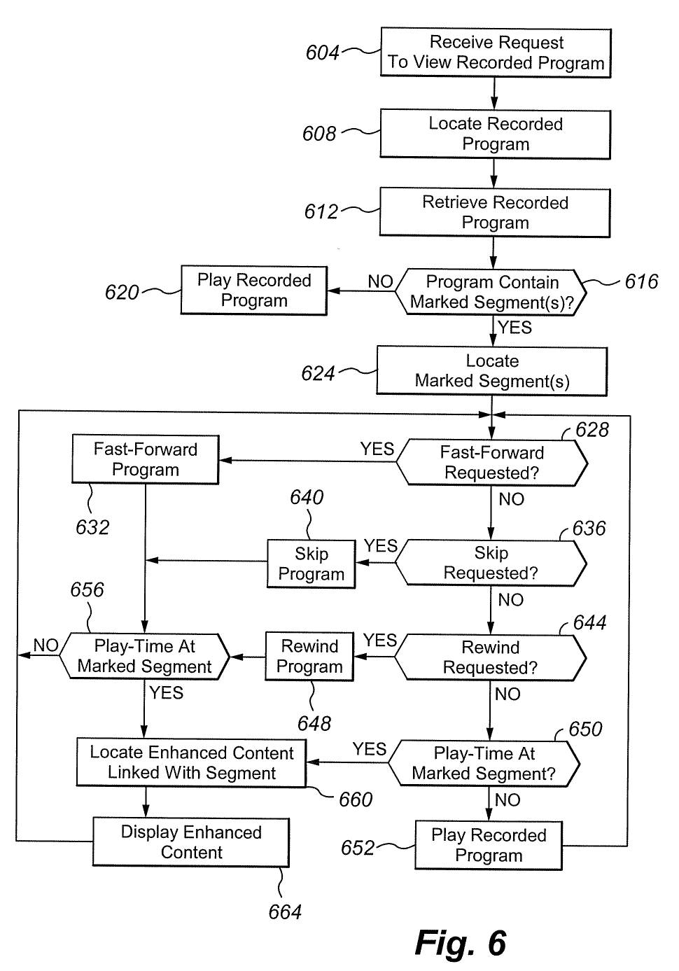

FIG. 6 is a flow chart depicting a method of presenting a recorded program in accordance with at least some embodiments of the present invention. Initially, a request to view a recorded program is received (step 604). The request to view a program may be received when a portable data storage device is inserted into a reader device. The request may also be issued by a user employing the viewer control interface 240 to select a recorded program 228 from a list of recorded programs. In response to receiving the request to view the recorded program 228, the recorded program 228 is located on the memory where it was stored (step 608). The memory used to store the recorded program 228 may include the memory 216 resident on the STB 124 or a memory or data storage area associated with the broadcast head end server 108 and/or advertisement database 120. Thereafter, the recorded program 228 is retrieved from appropriate memory location and prepared for presentation to the requesting user (step 612).

After the recorded program 228 has been retrieved, it is determined whether the recorded program 228 has any marked segments (step 616). More specifically, it is determined whether the recorded program 228 has any segments of interest that are linked with enhanced content 224 or a given memory location. The advertisement agent 112, 232 may maintain a table identifying what recorded programs 228, if any, have a segment or segments of interest, and if so where those segments are located within the recorded program 228. If it is determined that the retrieved recorded program 228 does not have any segments of interest, then the recorded program is presented to the user in the normal fashion (step 620). In other words, the user is allowed to control the viewing experience of the recorded program 228 (e.g., fast-forward, reverse, skip, pause, slow-motion, etc.) without any processing steps that would otherwise occur if the recorded program 228 had a segment of interest.

On the other hand, if the recorded program 228 comprises at least one segment of interest, then the method continues by locating marked segment(s) of interest within the recorded program (step 624). The boundaries of the segment of interest may be located by identifying the beginning and end of each segment. The markers of each segment of interest are used to determine when a particular segment of interest is being presented or will soon be presented. The advertisement agent 112, 232 may maintain the location of the markers in dynamically populated tables while the recorded program 228 is being presented to the user.

While the user is being presented with the recorded program 228, it is determined if a request to fast-forward the recorded program 228 has been received (step 628). If the user engages a fast-forward selector on the viewer control interface 240, then the request for fast-forward may be received at the user interface 212 where it is forwarded to the processor 204. If the processor 204 receives a request to fast-forward the recorded program 228, then the recorded program 228 is fast-forwarded in a typical fashion. During the fast-forward operation the recorded program 228 is presented to the user at a faster than real-time speed. In other words, the presentation duration of a particular portion of the recorded program 228 is reduced as compared to the real-time presentation duration of the same portion. However, the fast-forward operation, which may also be known as a scan operation, continues to display every frame or captured portion of the recorded program 228. Of course, if an extreme fast-forward operation is used, such that the recorded program 228 is fast-forwarded at a speed five times greater than real-time speed, then some frames or captured portions may be skipped even though the operation is still defined as a fast-forward operation.

If no request for fast-forward has been received, then it is determined if a skip has been requested (step 636). The skip operation differs from a fast-forward operation in that a predetermined amount of time is skipped in the recorded program. Different intervals of time may be skipped based on user preference and the member of skip requests received. If a request for the skip operation has been requested, then the recorded program 228 skips, either forward or backward, the predetermined amount of time (step 640). In one embodiment, a skip request may result in the recorded program 228 moving either forward or backward about 30 seconds from its previous presentation location. Of course, a request for a backwards skip may cause the recorded program 228 to skip backwards by a smaller amount of time as compared to a forward skip.

If neither a skip nor a fast-forward request has been received, then it is determined if a rewind or reverse request has been received at the processor 204 (step 644). The rewind operation is similar to that of the fast-forward operation in that a predetermined amount of time is generally not skipped, unless an extreme rewind request has been received, except that the rewind operation reverses back to a previous point in time on the recorded program 228 whereas a fast-forward operation moves forward to a future point in time on the recorded program 228. If a request to rewind the recorded program 228 is received, then the processor 204 rewinds the recorded program 228 (step 644). As can be appreciated by one skilled in the art, the actual act of fast-forwarding, skipping, and rewinding are terms used to describe altering the playback speed of a recorded program 228. They do not necessarily require that a tape be rewound or fast-forwarded. Rather, especially in embodiments employing a random access type of memory, the presentation of a recorded program 228 is altered by accessing different locations of the recorded program 228 on memory.

If no type of speed shifting display is requested, then it is determined if the play-time is at or near a marked segment of interest (step 650). This determination may be made by comparing the location of the display time indicator 420 to the known locations of the segment(s) of interest. Alternatively, if segment of interest is currently being displayed or will soon be displayed, then an alert may be sent to the advertisement agent 112, 232. If there have been no requests to alter the playback speed of the recorded program 228 and there is currently no segment of interest being presented or soon to be presented, then the recorded program 228 is played at the normal speed and presented to the viewer accordingly (step 652). In this embodiment, the user is essentially viewing the original program via the recorded program 228 in a time-shifted manner.

If any type of speed shifting display is requested, such as fast-forward, skip, or rewind, then the advertisement agent 112, 232 further determines if the play-time is at a marked segment of interest or will soon be at a marked segment of interest (step 656). In this embodiment, the advertisement agent 112, 232 compares the location of the display time indicator 420 to the known locations of the segment(s) of interest. If the display time indicator 420 is at or near a boundary of a segment of interest, or within a segment of interest, then the query in step 656 is answered affirmatively.

If the advertisement agent 112, 232 determines that a segment of interest is or will soon be presented to the user, either from steps 650 or 656, then the enhanced content 224 linked with the segment of interest is located (step 660). The enhanced content 224 may be located and retrieved from the STB 124 memory 216. Alternatively, the enhanced content 224 may reside in the advertisement database 120 in which case the enhanced content 224 is transmitted to the display apparatus 228 from the broadcast head end server 108. The enhanced content 224 may be transmitted during VBIs of a broadcast program. Alternatively, if the recorded program 228 corresponds to an on-demand type of program that is stored on the broadcast head end 108 side of the transmission network 104, then the enhanced content 224 may be inserted into the segment of interest prior to transmitting the on-demand recorded program 228. The enhanced content 224 may also be dynamically located by using a pointer associated with the segment of interest. The pointer may identify the memory location where the linked enhanced content 224 can be found.

Once the enhanced content 224 has been located, it is retrieved and presented to the user during the segment of interest (step 664). In accordance with at least some embodiments of the present invention, the presentation duration of the enhanced content 224 may be altered to fit into the presentation duration of the segment of interest. Accordingly, if the recorded program 228 is being fast-forwarded or presented at a non-real-time speed, then the duration of the enhanced content 224 may be altered to fit within the adjusted presentation duration of the segment of interest.

After the enhanced content 224 has been presented to the user, the method returns to step 628 to monitor the viewing actions of the recorded program 228 as well as determine if any more segments of interest are being played. Reverting back to step 656, if the play-time is not currently at or near the marked segment of interest, then the method returns to step 628 in a similar fashion to the return to step 628 from step 664.

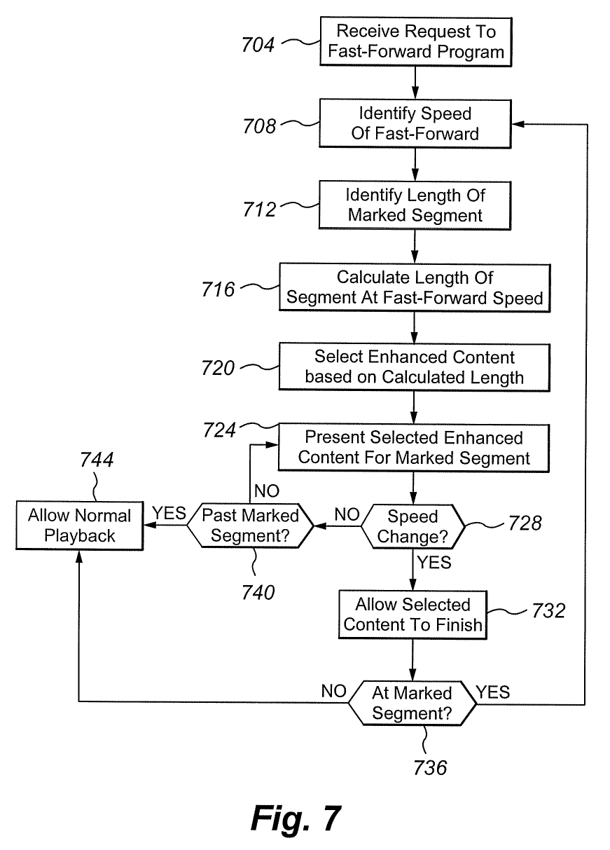

FIG. 7 is a flow chart depicting a method of selecting an enhanced content 224 for presentation during a segment of interest in accordance with at least some embodiments of the present invention. Although the following method will be described in connection with fast-forwarding a recorded program 228, one skilled in the art will appreciate that the following method can be applied to other time-shifted presentations of the recorded program 228 such as a an actual speed presentation and non-actual-speed presentations. Examples of other non-actual speed presentation include, skipping, rewinding, slow-motion, and the like. Initially, the method begins when a request to fast-forward a recorded program 228 is received (step 704). Thereafter, the speed of the requested fast-forward operation is identified (step 708). There may be a number of different fast-forward speeds supported by the processor 204, such as ½× real-time speed, 2× real-time speed, 5× real-time speed, 10× real-time speed, and any integer or non-integer multiple of real-time presentation speed.

After the fast-forward speed has been identified, the length of the marked segment of interest is determined (step 712). In determining the length of the segment of interest the difference in time between the beginning and end of the segment of interest may be calculated. Alternatively, the length of the segment of interest may be known or otherwise stored in a look up table maintained by the advertisement agent 112, 232. The length of the segment of interest is generally defined by the real-time presentation time of the segment of interest. In other words, if the segment of interest occupies ninety seconds of time on the recorded program 228, then the length of the segment of interest is determined to be ninety seconds.

With the normal presentation length of the segment of interest known as well as the fast-forward speed, the advertisement application 112, 232 calculates the length or duration of the segment of interest at the fast-forward speed (step 716). This calculation may be made by dividing the duration of the segment of interest by the fast-forward speed (as compared to real-time presentation speed). Based on the calculation an estimate can be made as to the actual presentation duration of the segment of interest at the fast-forward speed.

Based on the calculated information, the advertisement application 112, 232 may then selected an enhanced content 224 for presentation during the segment of interest (step 720). In this step, the advertisement application 112, 232 may select an enhanced content 224 from a list of enhanced contents 224 based on the duration of the enhanced content. Some enhanced contents may be shorter or longer as compared to others, so the selection of the enhanced content 224 may vary depending upon the presentation duration of the segment of interest. In accordance with one embodiment, an enhanced content 224 may comprise a still image such as a brand, logo, cartoon, or the like. Such an enhanced content 224 would be most suitable for a relatively short presentation duration of the segment of interest. On the other hand, an interactive enhanced content 224 may be selected for a short presentation duration because the interactive enhanced content 224 may allow the user to elect whether they would like to view the enhanced content 224 or not.

After the enhanced content 224 has been selected from the candidate enhanced contents, the selected enhanced content 224 is presented to the user during the segment of interest (step 724). In one embodiment, the presentation of the enhanced content 224 may fill the entire presentation duration of the segment of interest. In another embodiment, the presentation of the enhanced content 224 may last for shorter or longer than the presentation duration of the segment of interest.

While the enhanced content 224 is being presented to the user, it is determined if the speed of presentation has changed (step 728). The advertisement agent 112, 232 may be operable to continue monitoring the playback speed of the recorded program 228 to determine if there has been a request to either speed up or slow down the presentation speed of the recorded program 228.

If there has not been a change to the presentation speed, then the advertisement agent 112, 232 determines if the presentation of the segment of interest has completed (step 740). This may be determined by comparing the display time indicator 420 to the boundaries of the segment of interest. If the indicator 420 is within the boundaries, then the presentation of the marked segment has not completed. On the other hand, if the indicator 420 is outside of the boundaries, then it may be determined that the presentation of the segment of interest is completed. In the event that the presentation of the segment of interest has not completed, then the method returns to step 724 and the selected enhanced content 224 is presented to the user. On the other hand, if the presentation of the segment of interest has completed, then the recorded program 228 is allowed to be fast-forwarded in a normal fashion (step 744). In one embodiment, the recorded program 228 may be presented without continued presentation of the enhanced content 224.

Referring back to step 728, if it is determined that the playback speed of the recorded program 228 has altered, then the method continues by allowing the selected enhanced content to complete its presentation (step 732). Therefore, if the presentation speed of the recorded program 228 is increased, then the enhanced content 224 may run longer than the presentation of the segment of interest, in which case the recorded program 228 may be paused momentarily at the end of the segment of interest until presentation of the enhanced content 224 is complete. Alternatively, if the presentation speed of the recorded program 228 is decreased, then the enhanced content 224 may finish before the end of the segment of interest is reached, in which case the presentation of the recorded program 228 does not need to be paused to wait for the enhanced content 224 to finish.

After the presentation of the enhanced content 224 has completed, the advertisement agent 112, 232 determines whether a marked segment of interest is being presented to the user still (step 736). The segment of interest being displayed may be the same segment of interest as the first segment of interest or may be a different segment of interest that succeeded the first segment of interest. If the play-time is no longer within a segment of interest, then the normal playback of the recorded program 228 is allowed (step 744).

However, if there is still a marked segment of interest being presented to the user, then the method returns to step 708 to re-calculate the playback speed of the recorded program 228. This may allow the presentation of multiple enhanced contents 224 during a single segment of interest, depending upon the presentation duration of the segment of interest and the presentation duration of the selected enhanced contents 224.

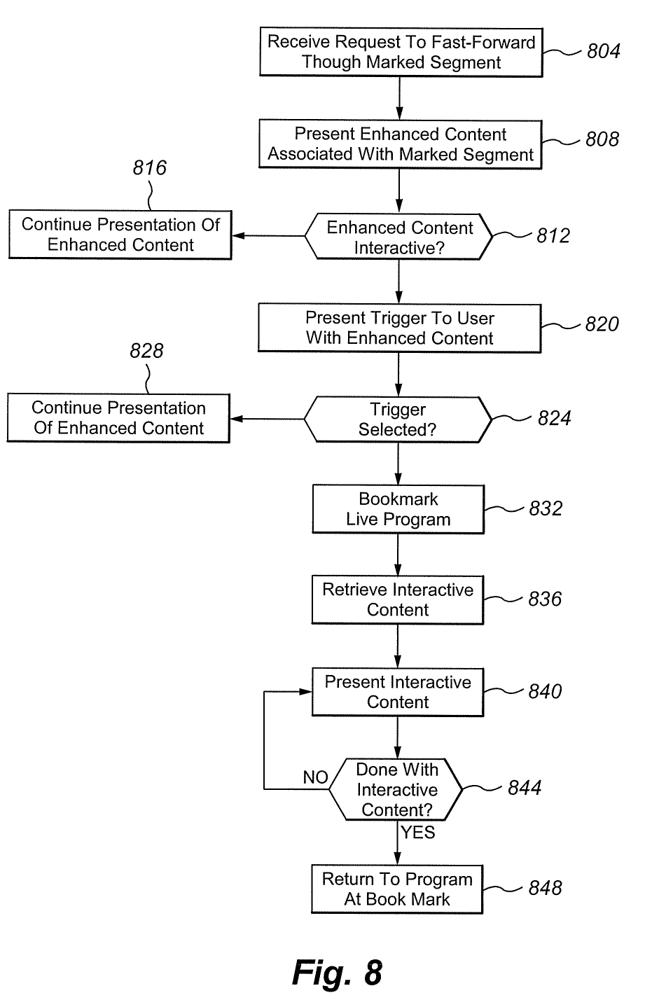

With reference now to FIG. 8, a method of engaging an interactive type of enhanced content 224 will be described in accordance with at least some embodiments of the present invention. This particular method will also be described in relation to a fast-forward operation, although one skilled in the art will appreciate that alternative playback operational modes may be equally supported by the same description. The method begins when a request to fast-forward through a marked segment of interest is received at the processor 204 (step 804). In response to receiving this request, an appropriate enhanced content 224 linked to or otherwise associated with the segment of interest is retrieved and presented to the viewer (step 808). Thereafter, it is determined if the enhanced content 224 in an interactive application (step 812). Examples of interactive applications include, without limitation, short-form interactive advertisements, long-form interactive advertisements, interactive games, polling applications, and other types of interactive applications. An interactive enhanced content 224 may be stored with an indicator bit that, when having a predetermined value (e.g., a logical zero or one), can be read by the advertisement application 112, 232 to determine if the enhanced content 224 is an interactive type of enhanced content 224. Alternatively, if the enhanced content 224 is stored with a trigger or similar type of mechanism that supports interactivity with the enhanced content 224, then it may be assumed that the enhanced content 224 is interactive.

In the event that the enhanced content 224 is not interactive, then the presentation of the enhanced content 224 occurs in the normal manner (step 816). The normal presentation of the enhanced content 224 may be to continue presenting the enhanced content 224 to the user until presentation of the enhanced content 224 has completed (e.g., the entire enhanced content 224 has been displayed). On the other hand, if the enhanced content 224 is interactive, then a trigger or other type of mechanism that supports interactivity is presented along with the enhanced content 224 (step 820).

While the enhanced content 224 aid corresponding trigger are presented to the user, the activity associated with the trigger is monitored (step 824). In the event that the trigger is not selected, then the enhanced content 224 is still presented to the user in a non-interactive format. If the enhanced content 224 was entirely comprised of interactive content, then the enhanced content 224 is not presented but only the trigger is presented.

However, if the trigger is selected, then the recorded program 228 is book marked at the point in time where the trigger was selected (step 832). Selection of the trigger may used as an indicator that the user desired to go interactive and temporarily leave the presentation of the recorded program 228, in which case the presentation of the enhanced content 224 will preempt the presentation of the recorded program 228. In such a situation, the book mark is useful for later use because it allows the presentation of the recorded program to resume where the user left the recorded program 228. Alternatively, the interactive enhanced content 224 may be presented to the user along with the recorded program 228. Still, the use of a book mark may be helpful even in embodiments where the enhanced content 224 is presented simultaneously with the recorded program 228.

After the recorded program 228 has been book marked, the interactive enhanced content 224 associated with the selected trigger is retrieved from the proper memory location (step 836). In one embodiment, the trigger comprises a pointer to the proper memory location such that when the trigger is selected, the data from the corresponding memory location is retrieved automatically. Thereafter, the enhanced content 224 is presented to the user (step 840). The user may continue interacting with the enhanced content for as long as desired. Accordingly, in step 844 it is determined if the user is done with the interactive enhanced content 224. If the user has not shown an indication that they are done interacting with the enhanced content 224, then the method returns to step 840 where interactive content is presented to the user, and the user is allowed to navigate various parts of the enhanced content 224 by selecting various triggers embedded within the interactive content 224.

The user may ultimately indicate that interaction with the enhanced content 224 is no longer desired by selecting an exit trigger or by pressing the play button associated with the recorded program 228. If the user is done interacting with the interactive enhanced content 224, then the processor 204 locates the book mark and continues presentation of the recorded program 228 from the point in time corresponding to the location of the book mark (step 848). This essentially allows the user to interact with the enhanced content 224 on a full screen basis then return to the segment of interest where the presentation of the recorded program 228 ended. In accordance with at least one embodiment of the present invention, the presentation of the recorded program 228 may resume at the exact point where the book mark is located. In other embodiments of the present invention, the presentation of the recorded program 228 may resume at the beginning or end of the segment of interest. For example, if the book mark is located within a segment of interest (i.e., between the beginning and end of the segment of interest), then the presentation may resume at the end of the segment of interest marked by the book mark.

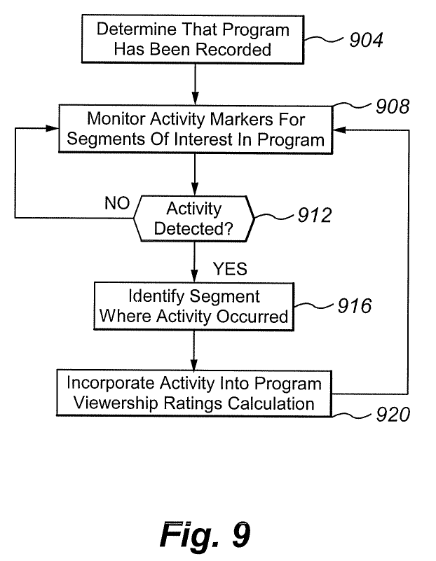

FIG. 9 is a flow chart depicting a method of calculating viewer ratings for a given program in accordance with at least some embodiments of the present invention. Typically, TV viewer ratings are based on the number of viewers of a live program. There are other rating methods that account for the number of times that a given program has been recorded. However, since the cost of advertisement space for TV programs is closely tied to viewer ratings, it would be advantageous to account for the actual number of segments of interest that are viewed and correspondingly the number of enhanced contents 224 that are viewed and in some instances interacted with by one or a number of users.

The method begins by determining that a program has been recorded (step 904). The act of determining that a particular program has been recorded may be accomplished by monitoring the activity of the memory 216 on the STB 124. If content is being added to the data storage 220, then the program currently being broadcast to and viewed by the user can be assumed to be recorded. Some STBs 124 are equipped with multiple tuners, in which case it should be determined which tuner the program is being recorded from before identifying that the actual program that is being recorded. Alternatively, the name of the program may be stored in memory along with the program itself. Transmission of the name back to the broadcast head end 108 may allow the recording of the program to be accounted for. Of course, there are other methods of determining that a program has been recorded which are well known in the art, and each of those methods are equally applicable to embodiments of the present invention.

After it has been determined that a program has been recorded, the advertisement agent 112, 232 monitors the activity associated with the segment(s) of interest in the recorded program 228 (step 908). While monitoring the segment(s) of interest, it is determined if any activity has been detected (step 912). If no activity has been detected, then the method returns to step 908 to continue monitoring the activity of the segment of interest.

In the event that activity associated with a segment of interest has been detected, then the segment of interest where the activity occurred is identified by the advertisement agent 112, 232 (step 916). Activity information for the segment may be determined by identifying when the segment of interest or the corresponding time slot in the recorded program 228 is either being presented to the user, fast-forwarded through, skipped, rewound through, or the like. Each segment of interest may correspond to a different enhanced content so it may be important to identify the segment of interest specifically, such that it can be determined which enhanced content has been presented to the user.

After identifying the segment of interest having activity detected in association therewith, the method continues by incorporating that activity into the program viewership ratings calculation (step 920). Regardless of the type of viewership ratings used, the activity of a segment of interest may be incorporated into the calculations to provide a more accurate picture of how many viewers are actually viewing a given segment of interest. It is further advantageous to base the viewer ratings on activity associated with the segment, because if there is a type of user activity associated with a segment of interest (e.g., a user fast-forwards through, skips, or reverses through a segment of interest) one can more accurately assume that the user is in front of display apparatus 128 and are receiving the message that is transmitted by the enhanced content 224. This may allow broadcast stations and other program providers to adjust the costs of certain segments of interest or at least costs of advertising during a particular program because the ratings calculations more accurately reflect not only what channel a STB 124 is tuned in to, but also whether viewers are in front of the display apparatus 128.

While the above-described flowcharts have been discussed in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols of this invention can be implemented on a special purpose computer in addition to or in place of the described STB, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a phone, any comparable means, or the like. In general, any device capable of implementing a state machine that is in turn capable of implementing the methodology illustrated herein can be used to implement the various communication methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and television arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems and methods for advertisement enhancement. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. A method, comprising:
recording a program broadcast as a Television (TV) signal;
identifying a first segment of interest in the recorded program, wherein a first content is displayed during a real-time presentation of the first segment;
displaying an enhanced content during a non-real-time presentation of the first segment of interest, wherein the enhanced content differs from the first content.

2. The method of claim 1, further comprising:
determining that the first segment of interest is being displayed in a time-shifted manner;
retrieving the enhanced content from memory; and
displaying the enhanced content during the time allocated to the first segment of interest.

3. The method of claim 2, wherein determining that the first segment of interest is being displayed in a time-shifted manner comprises at least one of the following:
a) determining that the first segment of interest is being fast-forwarded;
b) determining that the first segment of interest is being played in slow motion;
c) determining that the first segment of interest is being reversed; and
d) determining that the first segment of interest is being skipped.

4. The method of claim 3, wherein a) is true and the enhanced content is shorter in duration than the first content.

5. The method of claim 3, wherein b) is true and the enhanced content is longer in duration than the first content.

6. The method of claim 3, wherein d) is true and the enhanced content comprises a still image.

7. The method of claim 2, wherein determining that the first segment of interest is being displayed in a time-shifted manner comprises determining that the first segment of interest is being displayed at a non real-time speed, and wherein displaying the enhanced content during the time allocated to the first segment of interest comprises simultaneously displaying the first content and the enhanced content on a common display apparatus.

8. The method of claim 2, wherein the enhanced content is an update to the first content, the method further comprising:
receiving the enhanced content from a broadcast signal;
determining a memory location used to store the first content;
storing the enhanced content in the memory location such that the enhanced content replaces the first content;
in response to determining that the first segment of interest is being displayed, locating the enhanced content in the memory location with a pointer associated with the first segment of interest; and
presenting the enhanced content during the time allocated to the first segment of interest instead of presenting the first content.

9. The method of claim 8, further comprising downloading the enhanced content to a STB during VBIs of the broadcast.

10. The method of claim 1, further comprising:
determining that a trigger has been selected, thereby indicating that engagement of an interactive application is requested;
marking the recorded program at the point in time where the trigger was selected;
presenting the interactive application instead of the broadcast signal;
determining that the engagement of the interactive application has completed; and
returning to the recorded program at the marked point in time; and
starting presentation of the recorded program from the mark.

11. The method of claim 1, further comprising:
determining a speed of playback of the recorded first segment of interest;
calculating a duration of the first segment of interest at the determined speed;
identifying an enhanced content comprising a duration acceptable for display during the calculated duration from a set of enhanced contents; and
selecting the enhanced content for display during the presentation of the first segment of interest.

12. A computer readable medium comprising processor executable instructions for performing the method of claim 1.

13. An enhanced television apparatus, comprising:
a receiver adapted to receive multi-media signals;
a memory device comprising a data storage area, wherein a program received at the receiver can be stored in the data storage area; and
a processor operable to perform at least the following:
identify a first segment of interest corresponding to a first content in the recorded program;
determine that the first segment of interest is being presented after the first segment of interest was recorded; and
in response thereto present an enhanced content during the first segment of interest.

14. The apparatus of claim 13, wherein during the display of the recorded first segment of interest, the processor is operable to prepare the first content for display on a first portion of a display apparatus and the enhanced content for display on a second portion of the display apparatus.

15. The system of claim 13, wherein the enhanced content comprises at least one of an interactive advertisement, an updated advertisement, a short advertisement, and a still image.

16. The system of claim 13, wherein during the display of the recorded first segment of interest, the processor is operable to prepare the enhanced content for display instead of the first content.

17. The system of claim 13, wherein the first segment of interest is recorded with at least one pointer to a memory location, wherein the memory location is initially used to store the first content.

18. The system of claim 17, wherein the enhanced content replaces the first content in the memory location, and wherein the at least one pointer continues to point to the memory location such that when the first segment of interest is played, the enhanced content is presented during the first segment of interest.

19. The system of claim 17, wherein the at least one pointer comprises a trigger having a corresponding Universal Resource Locator (URL) that provides a memory address corresponding to the memory location.

20. A method, comprising:
presenting a multi-media program comprising a segment of interest having a real-time presentation duration;
determining that the segment of interest is currently being presented;
retrieving an enhanced content from memory;
preparing the enhanced content for presentation during the segment of interest; and
inserting the enhanced content into the segment of interest.

21. The method of claim 20, wherein the enhanced content comprises a presentation duration substantially similar to the real-time presentation duration of the segment of interest and wherein the enhanced content is displayed instead of content that was recorded during the segment of interest.

22. The method of claim 20, wherein the enhanced content comprises interactive content, the method further comprising:
recording the program;
marking the point in time corresponding to the beginning of the segment of interest;
allowing a user to interact with the interactive content;
determining that the user is done interacting with the interactive content; and
resuming presentation of the program at one of the following points of the recorded program:
a) the marked point in time corresponding to the beginning of the segment of interest; and
b) a point in time corresponding to the end of the segment of interest.

23. The method of claim 20, wherein enhanced content comprises at least one of an interactive advertisement, an updated advertisement, a short advertisement, and a still image.

24. The method of claim 20, wherein the duration of the enhanced content is shorter than the real-time duration of the segment of interest further comprising:
determining that the program is being at least one of fast-forwarded and skipped such that the actual presentation duration of the segment of interest is shorter than the real-time presentation duration of the segment of interest; and
displaying the enhanced content during the shorter than real-time duration of the segment of interest.

25. The method of claim 20, wherein the program is presented from memory.

26. The method of claim 20, wherein presentation of the program is from a live Television (TV) broadcast.
